(19) United States
(12) Patent Application Publication
(10) Pub. No.: US 2019/0339738 A1
(43) Pub. Date: Nov. 7, 2019

(54) Electronic Apparatus and Foldable Display Screen

(71) Applicant: Guangdong Oppo Mobile Telecommunications Corp., Ltd., Dongguan (CN)

(72) Inventor: Xiang Hou, Dongguan (CN)

(21) Appl. No.: 16/372,789

(22) Filed: Apr. 2, 2019

(30) Foreign Application Priority Data
May 4, 2018 (CN) 201810430424.X

(51) Int. Cl. G06F 1/16; G09F 9/30

(52) U.S. Cl. CPC G06F 1/1616; G09F 9/301; G06F 1/1641

(57) ABSTRACT

An electronic apparatus includes a casing and a foldable display screen. The casing includes a first frame, a middle frame having a first side and a second side opposite the first side, and a second frame. The first frame is rotatably attached to the first side of the middle frame and the second frame is rotatably attached to the second side of the middle frame. The foldable display screen includes a back surface attached to the casing and a display surface opposite the back surface. The display foldable screen is folded along the first side of the middle frame to be in a first state, and is folded along the second side to be in a second state. The display surface is invisible in the first state. Part of the display surface is visible and remaining part of the display surface is invisible in the second state.

### CROSS-REFERENCE TO RELATED APPLICATION(S)

The present application claims priority to Chinese disclosure Patent Application No. 201810430424.X, filed on May 4, 2018, the content of which is hereby incorporated by reference in its entirety.

### TECHNICAL FIELD

The present disclosure relates to the field of electronic apparatus, and more particularly to an electronic apparatus and a foldable display screen.

### BACKGROUND

With the development of flexible screens, foldable display devices are available now. The existing foldable display device generally may be a roll-type display device or a symmetric foldable display device. However, the roll-type display device requires a complicated driving mechanism and a flexible screen of the scroll type display device is prone to being torn due to forcible pulling. When being folded, a screen of the symmetric foldable screen may be fully covered, and thus it is inconvenient for a user to view text prompt information or answer calls in time.

### SUMMARY

An electronic apparatus is provided. The electronic apparatus includes a casing and a foldable display screen. The casing includes a first frame, a middle frame having a first side and a second side opposite the first side, and a second frame. The first frame is rotatably attached to the first side of the middle frame and the second frame is rotatably attached to the second side of the middle frame. The foldable display screen includes a back surface attached to the middle frame, the first frame, and the second frame of the casing. The foldable display screen further includes a display surface opposite the back surface and configured to display visual information. The foldable display screen is operable to be folded along the first side of the middle frame to be in a first state, and is operable to be folded along the second side of the middle frame to be in a second state. The display surface is invisible in the first state. Part of the display surface is visible and remaining part of the display surface is invisible in the second state.

An electronic apparatus is further provided. The electronic apparatus includes a casing and a foldable display screen. The casing includes a first frame, a middle frame having a first side and a second side opposite the first side, and a second frame. The foldable display screen is operable to be folded along a first folding line corresponding to the first side of the middle frame to be in a first state, and is operable to be being folded along a second folding line corresponding to the second side of the middle frame to be in a second state. The second folding line is parallel to and spaced from the first folding line. The first folding line is a symmetrical center line of the foldable display screen. The foldable display screen is invisible in the first state. Part of the foldable display screen is visible and remaining part of the foldable display screen is invisible in the second state. The foldable display screen is visible in an unfolded state.

A foldable display screen is provided. The foldable display screen includes a back surface configured to be attached to a casing of an electronic apparatus, and a display surface opposite the back surface and configured to display visual information. The display foldable screen is configured to be folded to switch between a first state and a second state. The display surface is invisible in the first state. Part of the display surface is visible and remaining part of the display surface is invisible in the second state.

### BRIEF DESCRIPTION OF DRAWINGS

To better illustrate the technical solutions of embodiments of the present disclosure, the following descriptions will briefly illustrate the accompanying drawings described in the illustrated embodiments. Obviously, the following described accompanying drawings are merely some embodiments of the present disclosure. Those skilled in the art can obtain other accompanying drawings according to the described accompanying drawings without creative efforts.

FIG. 1 is a schematic structure view of an electronic apparatus according to a first embodiment of the present disclosure.

FIG. 2 is a schematic structure view of the electronic apparatus according to the first embodiment of the present disclosure, showing the electronic apparatus folded along a first folding line.

FIG. 3 is a schematic structure view of the electronic apparatus according to the first embodiment of the present disclosure, showing the electronic apparatus folded along a second folding line.

FIG. 4 is a schematic front view of the electronic apparatus of FIG. 3.

FIG. 5 is a schematic exploded perspective view of the electronic apparatus according to the first embodiment of the present disclosure.

FIG. 6 is an enlarged view of a portion VI of FIG. 5.

FIG. 7 is a schematic structure side view of the electronic apparatus of FIG. 5 folded along the second folding line.

FIG. 8 is a schematic structure view of an electronic apparatus according to a second embodiment of the present disclosure.

FIG. 9 is a schematic structure view of an electronic apparatus according to a third embodiment of the present disclosure.

FIG. 10 is a schematic structure view of an electronic apparatus according to a fourth embodiment of the present disclosure.

### DETAILED DESCRIPTION

Technical solutions of embodiments of the present disclosure will be described clearly and completely in combination with the accompanying drawings of the embodiments of the present disclosure. Obviously, the described embodiments are merely a part rather than all of embodiments of the present disclosure. All other embodiments obtained by those skilled in the art without creative efforts based on the embodiments of the present disclosure shall fall within the protection scope of the present disclosure.

In the description of the embodiments of the present disclosure, it can be understood that the orientation or positional relationship indicated by the terms “up”, “down”, “left”, “right”, or the like is based on the orientation or positional relationship illustrated in the drawings, and is merely for convenience of description and simplified description, rather than implied or indicating that the device or component referred to must have a particular orientation, a structure and operated in a particular orientation, and thus is not to be construed as limiting the present disclosure.

An electronic apparatus is provided. The electronic apparatus includes a casing and a foldable display screen. The casing includes a first frame, a middle frame having a first side and a second side opposite the first side, and a second frame. The first frame is rotatably attached to the first side of the middle frame and the second frame is rotatably attached to the second side of the middle frame. The foldable display screen includes a back surface attached to the middle frame, the first frame, and the second frame of the casing. The foldable display screen further includes a display surface opposite the back surface and configured to display visual information. The foldable display screen is operable to be folded along the first side of the middle frame to be in a first state, and is operable to be folded along the second side of the middle frame to be in a second state. The display surface is invisible in the first state. Part of the display surface is visible and remaining part of the display surface is invisible in the second state.

In at least one embodiment, the display surface further includes a first display area disposed at the first frame, a second display area disposed at the second frame, and a middle display area disposed at the middle frame and located between the first display area and the second display area. Part of the first display area is exposed in the second state. The second display area covers the middle display area and remaining part of the first display area in the second state. The part of the first display area is the part of the display surface and the remaining part of the first display area is the remaining part of the display surface.

In at least one embodiment, the first display area is fully covered by the second display area and the middle display area in the first state.

In at least one embodiment, the middle display area has a width equal to a width of the part of the first display area uncovered by the second display area in the second state.

In at least one embodiment, the first display area, the second display area, and the middle display area are all rectangular, and the first display area has an area equal to a sum of an area of the second display area and an area of the middle display area.

In at least one embodiment, the electronic apparatus further includes a main board, the main board includes a controller configured to control display of the first display area, the middle display area, and the second display area according to switch between the first state and the second state of the foldable display screen.

In at least one embodiment, the controller is configured to turn off the first display area, the middle display area, and the second display area in the first state, and to turn off the middle display area, the second display area, and the remaining part of the first display area covered by the second display area and turn on the part of the first display area in the second state.

In at least one embodiment, the controller is further configured to turn on the first display area, the middle display area, and the second display area when the foldable display screen is in an unfolded state.

In at least one embodiment, the electronic apparatus further includes a first position sensor disposed at the first frame and a second position sensor disposed at the second frame, the first position sensor and the second position sensor are electrically coupled to the controller, and the controller is configured to determine whether the foldable display screen is in the first state, the second state, the folded state according to a relative positional relationship between the first position sensor and the second position sensor.

In at least one embodiment, the controller is configured to determine that the foldable display screen is in the first state when a distance between the first position sensor and the second position sensor is less than a preset distance, the controller is further configured to determine that the foldable display screen is in the second state when a distance between the first position sensor and the second position sensor is equal to the preset distance, and the controller is further configured to determine that the foldable display screen is in the unfolded state when a distance between the first position sensor and the second position sensor is greater than the preset distance.

In at least one embodiment, the electronic apparatus further includes a first pressure sensor disposed at the first frame and a second pressure sensor disposed at the middle frame, the first pressure sensor and the second pressure sensor are electrically coupled to the controller, the controller is configured to determine that the foldable display screen is in the first state when both the first pressure sensor and the second sensor sense pressure, the controller is further configured to determine that the foldable display screen is in the second state when the second sensor rather the first sensor senses pressure, and the controller is further configured to determine that the foldable display screen is in the unfolded state when neither the first pressure sensor nor the second sensor senses pressure.

In at least one embodiment, the first frame and the middle frame defines a receiving space therebetween to receive a curved portion of the foldable display screen in the second state, and the second frame and the middle frame define a second receiving space therebetween to receive a curved portion of the foldable display screen in the second state.

In at least one embodiment, the electronic apparatus further includes connecting members, each of the connecting members includes a pair of first tabs disposed at the middle frame, a pair of second tabs disposed at the second frame or at the first frame, a connecting bar, and a pair of rotating shafts, the connecting bar has an end rotatably connected to the pairs of first tabs through one of the rotating shafts, and another end rotatable connected to the pair of second tabs through the other one of the rotating shafts.

In at least one embodiment, the connecting members are elastic pieces trips or hinges.

An electronic apparatus is further provided. The electronic apparatus includes a casing and a foldable display screen. The casing includes a first frame, a middle frame having a first side and a second side opposite the first side, and a second frame. The foldable display screen is operable to be folded along a first folding line corresponding to the first side of the middle frame to be in a first state, and is operable to be being folded along a second folding line corresponding to the second side of the middle frame to be in a second state. The second folding line is parallel to and spaced from the first folding line. The first folding line is a symmetrical center line of the foldable display screen. The foldable display screen is invisible in the first state. Part of the foldable display screen is visible and remaining part of the foldable display screen is invisible in the second state. The foldable display screen is visible in an unfolded state.

In at least one embodiment, the foldable display screen includes a first display area corresponding to the first frame, a second display area corresponding to the second frame, and a middle display area corresponding to the middle frame and located between the first display area and the second display area. The second display area covers the middle display area and the remaining part of the display screen in the second state. The part of the foldable display screen is exposed in the second state. The first display area is fully covered by the second display area and the middle display area in the first state.

A foldable display screen is provided. The foldable display screen includes a back surface configured to be attached to a casing of an electronic apparatus, and a display surface opposite the back surface and configured to display visual information. The display foldable screen is configured to be folded to switch between a first state and a second state. The display surface is invisible in the first state. Part of the display surface is visible and remaining part of the display surface is invisible in the second state.

In at least one embodiment, the display surface further includes a first display area, a second display area, and a middle display area having opposite sides and disposed between the first display area and the second display area, the first display area is rotatable relative to one side of the middle display area, the second display area is rotatable relative to the other side of the middle display area.

In at least one embodiment, part of the first display area is exposed in the second state. The second display area covers the middle display area and remaining part of the first display area in the second state. The part of the first display area is the part of the display surface and the remaining part of the first display area is the remaining part of the display surface. The first display area is fully covered by the second display area and the middle display area in the first state.

In at least one embodiment, the first display area, the second display area, and the middle display area are all rectangular, and the first display area has an area equal to a sum of an area of the second display area and an area of the middle display area.

In at least one embodiment, the middle display area has a width equal to a width of the part of the first display area uncovered by the second display area in the second state.

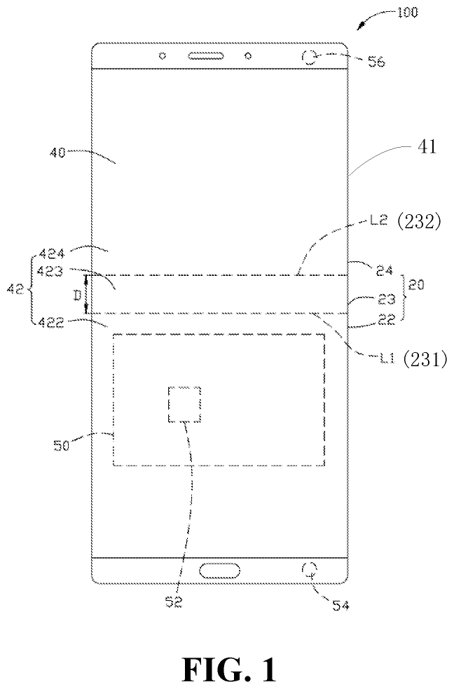

FIG. 1 illustrates a schematic structure view of an electronic apparatus according to a first embodiment of the present disclosure. An electronic apparatus 100 provided herein includes a casing 20 and a foldable display screen 40 attached to the casing 20. The casing 20 includes a first frame 22, a middle frame 23, and a second frame 24. The middle frame 23 has a first side 231 and a second side 232 parallel to and spaced from the first side 231. The first frame 22 is rotatably attached to the first side 231 of the middle frame 23. The second frame 24 is rotatably attached to the second side 232 of the middle frame 23. The second frame 24. The foldable display screen 40 has a back surface 41 attached to the casing 20 and a display surface 42 opposite the back surface 41. The display surface 42 is configured to display visual information. The display surface 42 has a first display area 422 disposed at the first frame 22, a second display area 424 disposed at the second frame 24, and a middle display area 423 disposed at the middle frame 23 and located between the first display area 422 and the second display area 424.

The foldable display screen 40 can be folded along the first side 231 of the middle frame 23 to be in a first state, and folded along the second side 232 of the middle frame 23 to be in a second state. The display surface 42 is invisible in the first state, and part 4220 of the display surface 42 is visible and remaining part 4221 of the display surface 42 is invisible in the second state. That is, the electronic apparatus 100 can be folded along the first side 231 of the middle frame 23 and the second side 232 of the middle frame 23.

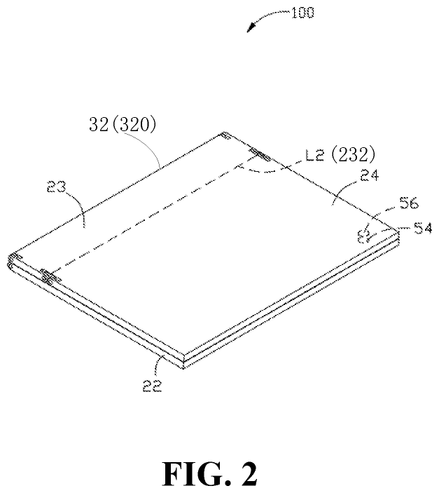

FIG. 2 illustrates a schematic structure view of the electronic apparatus according to the first embodiment of the present disclosure when the electronic apparatus is folded along a first folding line. The first side 231 of the middle frame 23 can act as a first folding line L1 and the second side 232 of the middle frame 23 can act as a second folding line L2. The first folding line L1 is a symmetrical center line of the foldable display screen 40. The second folding line L2 is parallel to and spaced from the symmetrical center line of the foldable display screen 40. After the foldable display screen 40 is folded along the first folding line L1 to be in the first state, the first display area 422 is fully covered by the second display area 424 and the middle display area 423.

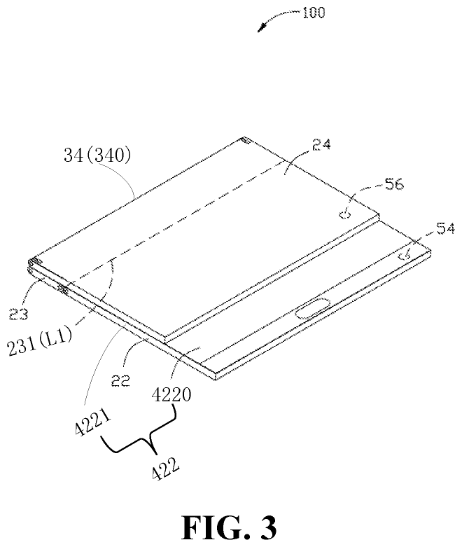

FIG. 3 illustrates a schematic structure view of the electronic apparatus according to the first embodiment of the present disclosure when the electronic apparatus is folded along a second folding line. After the foldable display screen 40 is folded along the second folding line L2 to be in the second state, part of the first display area 422 is exposed and visible, and remaining part of the first display area 422 is covered by the second display area 424 and invisible. The part of the first display area 422 is the part 4220 of the display surface 42 and the remaining part of the first display area 422 is the remaining part 4221 of the display surface 42.

In the illustrated embodiment, the electronic apparatus 100 is a mobile phone. It can be understood that in other embodiments, the electronic apparatus 100 can be, but is not limited to, a wireless phone, a pager, a web browser, a notepad, a calendar, and/or a global positioning system (GPS) receiver. In the illustrated embodiment, the foldable display screen 40 is a flexible screen.

When the foldable display screen 40 is in the second state, the second display area 424 covers the middle display area 423 and the remaining part 4221 of the first display area 422 such that the part 4220 is exposed on the first display area 422. The part 4220 can be controlled to display simple information, such as an incoming call, a text message prompt, a music playback, and calendar information and time information. Therefore, when the electronic apparatus 100 is folded along the second folding line L2 to be in the second state, the user can answer the call in time, acquire some simple information, and perform some simple operations through the part 4220, which is convenient to operate and can save power.

When the foldable display screen 40 is in the first state, the second display area 424 and the middle display area 423 fully cover the first display area 422. When the foldable display screen 40 is expanded to be in an unfolded state, the first display area 422, the second display area 424, and the middle display area 423 cooperatively form a large complete display area.

In the illustrated embodiment, the foldable display screen 40 is a rectangular flexible screen. The first folding line L1 coincides with a lateral symmetrical center line of the foldable display screen 40 and the second folding line L2 is parallel to and spaced from the first folding line L1. That is, the first folding line L1 and the second folding line L2 both extend in a direction parallel to the width direction of the foldable display screen 40. In the illustrated embodiment, the first display area 422, the second display area 424, and the middle display area 423 are all rectangular.

The second folding line L2 can be located at one side of the first folding line L1. That is, the second folding line L2 is located adjacent to a top end of the electronic apparatus 100 (i.e., a top end of the foldable display screen 40) or the second folding line L2 is located adjacent to a bottom end of the electronic apparatus 100 (i.e., a bottom end of the foldable display screen 40).

In the illustrated embodiment, when the second folding line L2 is located adjacent to the top end of the electronic apparatus 100, an area between the top end of the foldable display screen 40 and the second folding line L2 is the second display area 424, an area between the bottom end of the foldable display screen 40 and the first folding line L1 is the first display area 422, and an area between the first folding line L1 and the second folding line L2 of the foldable display screen 40 is the middle display area 423. An area of the first display area 422 is larger than an area of the second display area 424. The area of the first display area 422 is equal to a sum of the area of the second display area 424 and an area of the middle display area 423. After the foldable display screen 40 is folded along the first folding line L1 to be in the first state, the first display area 422 is fully covered by the second display area 424 and the middle display area 423. After the foldable display screen 40 is folded along the second folding line L2 to be in the second state, the second display area 424 covers the middle display area 423 and the remaining part 4221 of the first display area 422. The part 4220 of the first display area 422 is uncovered to be exposed.

In other embodiments, the second folding line L2 can be located adjacent to the bottom end of the electronic apparatus 100. That is, an area of an area between the top end of the foldable display screen 40 and the first folding line L1 is larger than an area of an area between the second folding line L2 and the bottom end of the foldable display screen 40. The area between the top end of the foldable display screen 42 and the first folding line L1 is as the first display area 422, the area between the second folding line L2 and the bottom end of the foldable display screen 40 is as the second display area 424, and an area between the first folding line L1 and the second folding line L2 of the foldable display screen 42 is as the middle display area 423. The area of the first display area 422 is larger than the area of the second display area 424 and is equal to a sum of the area of the second display area 424 and the area of the middle display area 423.

A distance D between the first folding line L1 and the second folding line L2 ranges from 10 mm to 30 mm. In the illustrated embodiment, the distance D between the first folding line L1 and the second folding line L2 is 10 mm.

The distance D between the first folding line L1 and the second folding line L2 is equal to a width of the part 4220. That is, the width of the part 4220 ranges from 10 mm to 30 mm. In the illustrated embodiment, the width of the part 4220 is 10 mm. In the second state, the part 4220 can be controlled to display an incoming call icon 4231, a text message prompt icon 4233, a music playback icon 4237, and a calendar information icon and time information icon 4238.

The electronic apparatus 100 further includes a main board 50 disposed at the first frame 22. The main board 50 includes a control circuit. The control circuit is configured to control the foldable display screen 40. The control circuit includes a controller 52. The controller 52 is configured to control display of the first display area 422, the middle display area 423, and the second display area 424 according to according to switch between the first state and the second state of the foldable display screen 40. In other embodiments, the main board 50 can be disposed at the second frame 24.

As illustrated in FIG. 2, after the foldable display screen 40 is folded along the first folding line L1 to be in the first state, the first display area 422 is fully covered by the middle display area 423 and the second display area 424. The controller 52 turns off the first display area 422, the middle display area 423, and the second display area 424.

As illustrated in FIG. 3, after the foldable display screen 40 is folded along the second folding line L2 to be in the second state, the middle display area 423 and the remaining part 4221 of the first display area 422 are covered by the second display area 424, and the part 4220 of the first display area 422 is exposed. The controller 52 turns off the middle display area 423, the second display area 424, and the remaining part 4221, and turns on the part 4220. At this time, only the part 4220 operates, which can save the power of the electronic apparatus 100 and reduce the loss to the foldable display screen 40.

When the foldable display screen 40 is in the unfolded state, the first display area 422, the middle display area 423, and the second display area 424 form the large complete display area. At this time, the controller 52 controls the first area 422, the middle display area 423, and the second display area 424 to be turned on, which provides a large display screen and improves the user experience.

The electronic apparatus 100 further comprises a pair of sensors to detect the state of the foldable display screen 40. One of the sensors is disposed at the first frame 22 and the other one of the sensors is disposed at the second frame 24.

In the illustrated embodiment, the sensors are a first position sensor 54 and a second position sensor 56. The first position sensor 54 is disposed at the first frame 22 and the second position sensor 56 is disposed at the second frame 24. The first position sensor 54 and the second position sensor 56 are electrically coupled to the controller 52. The controller 52 is configured to determine whether the foldable display screen 40 is in the first state, the second state, or in the unfolded state according to a relative positional relationship between the first position sensor 54 and the second position sensor 56. In other words, the controller 52 is configured to determine whether the foldable display screen 40 is in the first state, the second state, or in the unfolded state according to a distance between the first position sensor 54 and the second position sensor 56.

When the foldable display screen 40 is in the second state, the first position sensor 54 and the second position sensor 56 are spaced at a gap. A width of the gap is equal to the distance D between the first folding line L1 and the second folding line L2. That is, in the second state, the distance between the first position sensor 54 and the second position sensor 56 is equal to the distance D which can be set as a preset distance. In the first state, the first position sensor 54 aligns with the second position sensor 56, that is, the distance between the first position sensor 54 and the second position sensor 56 is less than the distance D. When the foldable display screen 40 is in the unfolded state, the distance between the first position sensor 54 and the second position sensor 56 is greater than the distance D, that is, the distance between the first position sensor 54 and the second position sensor 56 is greater than the distance D.

When the distance between the first position sensor 54 and the second position sensor 56 is less than to the preset distance, the controller 52 determines that the foldable display screen 40 is in the first state and turns off the first display area 422, the second display area 424, and the middle display area 423. When the distance between the first position sensor 54 and the second position sensor 56 is equal to the preset distance, the controller 52 determines that the foldable display screen 40 is in the second state and turns off the middle display area 423, the second display area 424, and the remaining part 4221 of the first display area 422, and turns on the part 4220. When the distance between the first position sensor 54 and the second position sensor 56 is greater than the preset distance, the controller 52 determines that the foldable display screen 40 is in the unfolded state and turns on the first display area 422, the middle display area 423, and the second display area 424, to enable the foldable display screen 42 to form the large complete display screen.

In the illustrated embodiment, the first position sensor 54 is located at one end of the first frame 22 away from the middle frame 23. The second position sensor 56 is located at one end of the second frame 24 away from the middle frame 23. That is, the first position sensor 54 is located at a bottom end of the casing 20, and the second position sensor 56 is located at a top end of the casing 20. When the foldable display screen 42 is folded along the first folding line L1 to be in the first state, the first position sensor 54 aligns with the second position sensor 56. When the foldable display screen 42 is folded along the second folding line L2 to be in the second state, the first position sensor 54 is spaced from the second at the distance D.

In other embodiments, the sensors can be a first pressure sensor and a second pressure sensor, to replace the first position sensor 54 and the second position sensor 56. The first pressure sensor is disposed at the end of the first frame 22 away from the middle frame 23 and the second pressure sensor is disposed at the middle frame 23. The first pressure sensor and the second pressure sensor are electrically coupled to the controller 52. The controller 52 is further configured to determine whether the foldable display screen 40 is in the first state, the second state, or the unfolded state according to pressure detected by the first pressure sensor and the second pressure sensor.

When the foldable display screen 40 is in the first state, the first display area 422 is fully covered by the second display area 424 and the middle display area 423. Thus, the first pressure sensor and the second pressure sensor both sense pressure applied thereto. In the second state, no pressure is applied to the first pressure sensor and only the second pressure sensor senses pressure. When the foldable display screen 40 is in the unfolded state, no pressure is applied to the first pressure sensor and the second pressure sensor.

When receiving a signal from the first pressure sensor and a signal from the second pressure sensor at the same time, the controller 52 determines that the foldable display screen 40 is in the first state and turns off the first display area 422, the second display area 424, and the middle display area 423. When only receiving a signal from the second pressure sensor, the controller 52 determines that the foldable display screen 40 is in the second state and turns off the middle display area 423, the second display area 424, and the remaining part 4221 of the first display area 422, and turns on the part 4220. Without receiving any signal from the first pressure sensor and the second pressure sensor, the controller 52 determines that the foldable display screen 40 is in the unfolded state, the controller 52 turns on the first display area 422, the middle display area 423, and the second display area 424, to form the large complete display screen.

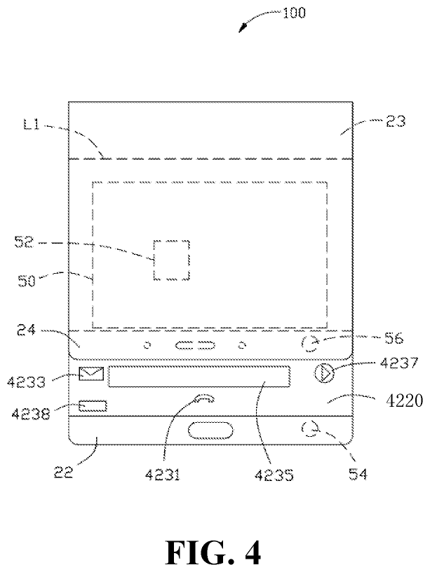

FIG. 4 illustrates a schematic front view of the electronic apparatus of FIG. 3. The part 4220 of the first display area 422 can be controlled to display the incoming call icon 4231. In the second state, when an incoming call is received, the controller 52 controls the incoming call icon 4231 to be displayed on the part 4220. At this time, the user can be allowed to answer the call without expanding the foldable display screen 40, which is convenient in use.

The part 4220 can be controlled to display the text message prompt icon 4233 and a text display box 4235. In the second state, when a text message is received, the controller 52 controls the text message prompt icon 4233 to be displayed on the part 4220. When the user clicks the text message prompt icon 4233, a sender of the text message and a summary of the text message are displayed in the text display box 4235, which facilitates conveniently viewing a content of the text message without expanding the foldable display screen 40. The summary of the text message can be set to be a part of the text message. For example, the first 10 words of the text message. Thus, the user can view the text message without expanding the foldable display screen 40, which is convenient in use.

In other embodiments, when the electronic apparatus 100 receives the text message, the controller 52 controls the text message prompt icon 4233 to be displayed. At the same time, the controller 52 controls the content of the text message to be displayed and scrolled in the text display box 4235.

The part 4220 can be controlled to display the music playback icon 4237. The controller 52 can identify a program that is running and displayed before the foldable display screen 40 is folded. For example, the electronic apparatus 100 plays a music when the foldable display screen 40 is in the unfolded state. The controller 52 controls the music playback icon 4237 to be displayed on the part 4220 and the electronic apparatus 100 continues to play the music when the foldable display screen 40 is folded to be in the second state. In this way, the user can listen to the music and operate the music playback icon 4237 without expanding the foldable display screen 40, which is convenient in use.

The part 4220 can be further controlled to display the calendar information and time information icon 4238. In the second state, the controller 52 controls the calendar information and time information icon to display a date and a time on the part 4220. Thus, the user can view the date and the time without expanding the foldable display screen 40, which is convenient in use.

In other embodiments, the part 4220 can also be controlled to display an icon for displaying the power amount, an icon for displaying the network, and the like, as needed.

When the large complete display screen is not required, the foldable display screen 40 of the electronic apparatus 100 is folded along the second folding line L2. In this way, the electronic apparatus 100 occupies less space and is convenient for the user to carry. In addition, the part 4220 can display simple information to enable the user to conveniently perform some simple operations and acquire some simple information, which is convenient in use and improves the user experience.

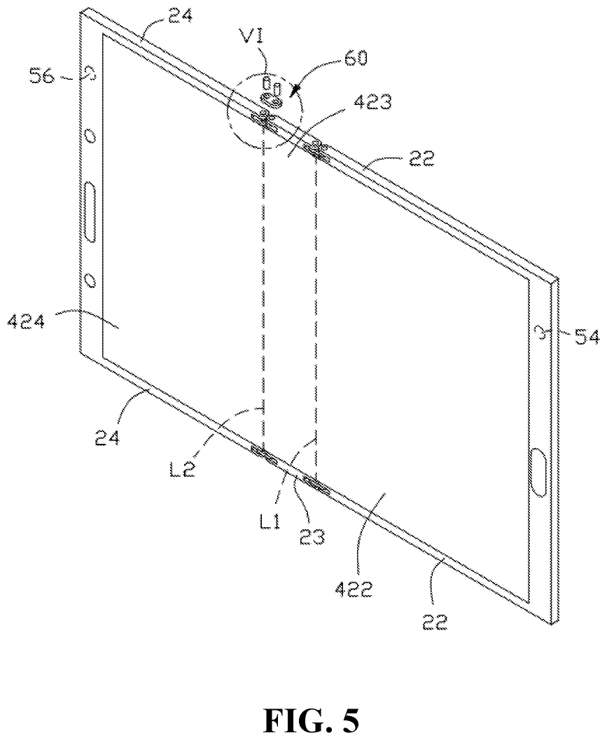

FIG. 5 illustrates a schematic perspective exploded view of the electronic apparatus according to the first embodiment of the present disclosure. The first frame 22 and the middle frame 23 of the electronic apparatus 100 are rotatably connected by two connecting members 60. The second frame 24 and the middle frame 23 of the electronic apparatus 100 are rotatably connected by two connecting members 60. The first folding line L1 extends the two connecting members 60 between the first frame 22 and the middle frame 23. The second folding line L2 extends through the two connecting members 60 between the second frame 24 and the middle frame 23. A receiving space 320 is defined between the first frame 22 and the middle frame 23 to receive a curved portion 32 of the foldable display screen 40 in the first state, as illustrated in FIG. 2. A receiving space 340 is defined between the second frame 24 and the middle frame 23 to receive a curved portion 34 of the foldable display screen 40 in the second state, as illustrated in FIG. 3. In this way, the foldable display screen 40 is prevented from being broken due to excessive folding.

Since the four connecting members 60 of the electronic apparatus 100 of the present disclosure have the same structure, only one of the connecting members 60 located between the second frame 24 and the middle frame 23 is described in detail.

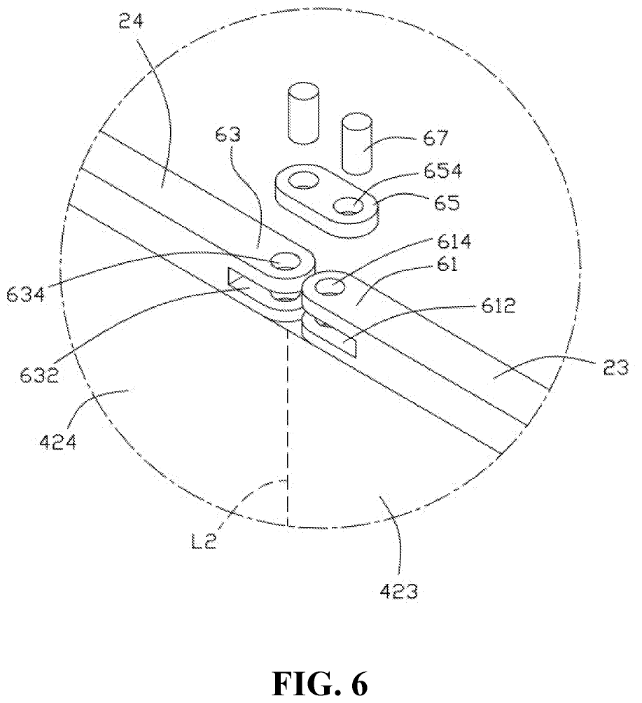

FIG. 6 illustrates an enlarged view of a portion VI of FIG. 5. The connecting member 60 includes a pair of first tabs 61 disposed at the middle frame 23, a pair of second tabs 63 disposed at the second frame 24, a connecting bar 65, and the two rotating shafts 67. A first connecting slot 612 is defined between the pair of first tabs 61 and a second connecting slot 632 is defined between the pair of second tabs 63. The connecting bar 65 are rotatably connected to the pair of second tabs 63 and the pair of first tabs 61. The first connecting slot 612 and the second connecting slots 632 both extend in a direction perpendicular to the second folding line L2. A pair of first shaft holes 614 is defined in distal ends of the first tabs 61 in the direction of the second folding line L2 and communicates the first connecting slot 612. A pair of second shaft holes 634 is defined in distal ends of the second tabs 63 in the direction of the second folding line L2 and communicates the second connecting slot 613. The connecting bar 65 is strip-shaped. Opposite ends of the connecting bar 65 are arc-shaped. Two connecting holes 654 are defined in the opposite ends of the connecting bar 65, respectively. In assembly, one end of the connecting bar 65 is received in the first connecting slot 612 and the other end of the connecting bar 65 is received in the second connecting slot 632. One of the rotating shafts 67 extends through the first shaft holes 614 and the corresponding connecting hole 654. The other one of the rotating shaft 67 extends through the second shaft holes 634 and the corresponding connecting hole 654. In this way, the second frame 24 is rotatably attached to the middle frame 23.

The opposite ends of the connecting bar 65 are configured to be arc-shaped, which can prevent the connecting bar 65 from being blocked during rotating, thereby smoothing the folding of the foldable display screen 40. Each of the ends of the first tabs 61 facing the second tabs 63 is configured to be arced-shaped, and each of the ends of the second tabs 63 facing the first tabs 61 is configured to be arc-shaped. In this way, the arced ends of the first tabs 61 and the second tabs 63 engage with each other to smooth the rotation of the first tabs 61 and the second tabs 63 and further beauty the appearance of the electronic apparatus 100.

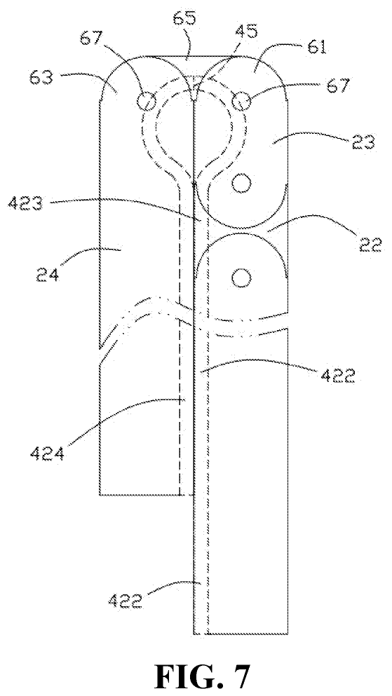

FIG. 7 illustrates a schematic structure side view of the electronic apparatus of FIG. 5 folded along the second folding line. When the foldable display screen 40 is folded along the second folding liner L2, the second frame 24 is rotated toward the middle frame 23 about the corresponding rotating shaft 67, or the middle frame 23 is rotated toward the second frame 24 about the corresponding rotating shaft 67. The curved portion 34 is formed between the second display area 424 and the middle display area 423, as illustrated in FIG. 3. The curved portion 34 is received in the receiving space 340 formed between the two connecting members 60, which can prevent the foldable display screen 40 from being broken due to excessive folding. At this time, a portion of the second display area 424 away from the second folding line L2 covers the first display area 422. The remaining part 4221 of the first display area 422 is covered and the part 4220 is exposed. The controller 52 controls the display of the middle display area 423, the second display area 424, and the remaining part 4221 of the first display area 422 to be turned off and controls the part 4220 to be turned on.

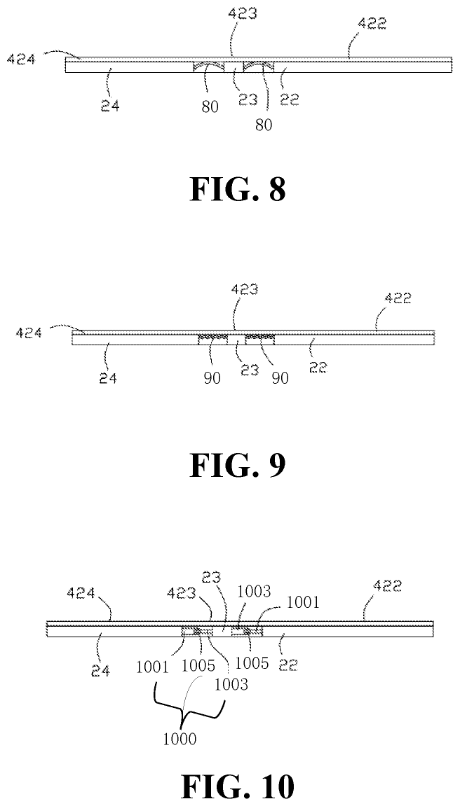

FIG. 8 illustrates a schematic structural view of an electronic apparatus according to a second embodiment of the present disclosure. The structure of the electronic apparatus of the present disclosure in the second embodiment is similar to that in the first embodiment, except that connecting members 80 between the first frame 22 and the middle frame 23 and connecting members 80 between the second frame 24 and the middle frame 23 in the second embodiment are different from the connecting members 60 in the first embodiment. In the second embodiment, the connecting members 80 between the first frame 22 and the middle frame 23, and the connecting members 80 between the second frame 24 and the middle frame 23 are elastic pieces. For the sake of brevity, only one of the connecting members 80 located between the second frame 24 and the middle frame 23 is described in detail. When the foldable display screen 40 is folded, the elastic pieces are elastically deformed and curved. When the foldable display screen 40 is folded along the first folding line L1, the curved portion 32 is formed between the first display area 422 and the middle display area 423. The curved elastic piece can protect the curved portion 32 of the foldable display screen 42 from being broken at the curved portion 32. When the foldable display screen 40 is folded along the second folding line L2, the elastic pieces are elastically deformed and curved, the curved portion 34 is formed between the second display area 424 and the middle display area 423. The elastic pieces can protect the curved portion 34 of the foldable display screen 40 from being broken. The elastic piece can be a flexible metal elastic piece, an elastic rubber piece, or an elastic plastic piece or the like. In the illustrated embodiment, the elastic piece is a soft metal elastic piece.

FIG. 9 illustrates a schematic structural view of an electronic apparatus according to a third embodiment of the present disclosure. The structure of the electronic apparatus of the present disclosure in the third embodiment is similar to that in the first embodiment, except that connecting members 90 between the first frame 22 and the middle frame 23 and connecting members between the second frames 24 and the middle frame 23 in the third embodiment are different from the connecting members 60 in the first embodiment. In the third embodiment, the connecting members 90 between the first frame 22 and the middle frame 23, and the connecting members 90 between the second frame 24 and the middle frame 23 are hinges. For the sake of brevity, only one of the connecting members 90 located between the second frame 24 and the middle frame 23 is described in detail. When the foldable display screen 40 is folded along the first folding line L2, the hinges are curved, and the curved portion 32 is formed between the first display area 422 and the middle display area 423. The hinges can protect the curved portion 32 from being broken. When the foldable display screen 40 is folded along the second folding line L2, the hinges are curved, and the curved portion 34 is formed between the second display area 424 and the middle display area 423. The hinges may protect the curved portion 32 from being broken. In the illustrated embodiment, the hinge is a damping hinge.

FIG. 10 illustrates a schematic structural view of an electronic apparatus according to a fourth embodiment of the present disclosure. The structure of the electronic apparatus of the present disclosure in the fourth embodiment is similar to that in the first embodiment, except that connecting members 1000 between the first frame 22 and the middle frame 23, and connecting members between the second frame 24 and the middle frame 23 in the fourth embodiment are different from the connecting members 60 in the first embodiment. In the fourth embodiment, the first frame 22 and the middle frame 23 are foldably connected by connecting members 1000, and the second frame 24 and the middle frame 23 are foldably connected by connecting members 1000. For the sake of brevity, only one of the connecting members 1000 located between the second frame 24 and the middle frame 23 is described in detail. The connecting member 1000 includes a first connecting piece 1001, a second connecting piece 1003, and a post 1005. The first connecting piece 1001 extends from the second frame 24 and the second connecting piece 1003 extends from the middle frame 23. The first connecting piece 1001 and the second connecting piece 1003 are rotatably connected by the post 1005.

When the foldable display screen 40 is folded along the first folding line L1, the first connecting pieces 1001 and the second connecting pieces 1003 are rotated about the corresponding posts 1005. Thus, the first display area 422 can be covered by the middle display area 423 and the second display area 424. When the foldable display screen 40 is folded along the second folding line L2, the first connecting pieces 1001 and the second connecting pieces 1003 are rotated about the corresponding posts 1005. Thus, the second display area 424 covers the remaining part 4221 of the first display area 422, the part 4220 is exposed, and the part 4220 is controlled to be turned on.

In the illustrated embodiment, when the foldable display screen is folded along the second folding line, the foldable display screen is asymmetrically folded such that the part of the foldable display screen is exposed and visible for displaying. The user can perform simple operations and acquire some simple information through the part of the foldable display screen, which is convenient to operate and save power.

The embodiments of the present disclosure have been described above. It should be noted that some modifications and improvements can be made by those skilled in the art within the spirit and principle of the above embodiments and those modifications and improvement should be included within the protection scope of the present disclosure.

What is claimed is:

1. An electronic apparatus, comprising:
a casing, comprising:
a middle frame having a first side and a second side opposite the first side;
a first frame rotatably attached to the first side of the middle frame; and
a second frame rotatably attached to the second side of the middle frame; and
a foldable display screen comprising:
a back surface attached to the middle frame, the first frame, and the second frame of the casing; and
a display surface opposite the back surface and configured to display visual information, wherein the foldable display screen is operable to be folded along the first side of the middle frame to be in a first state, the foldable display screen is operable to be folded along the second side of the middle frame to be in a second state, the display surface is invisible in the first state, part of the display surface is visible, and remaining part of the display surface is invisible in the second state.

2. The electronic apparatus of claim 1, wherein the display surface further comprises a first display area disposed at the first frame, a second display area is disposed at the second frame, and a middle display area is disposed at the middle frame and located between the first display area and the second display area, wherein part of the first display area is exposed in the second state, the second display area covers the middle display area and remaining part of the first display area in the second state, the part of the first display area is the part of the display surface and the remaining part of the first display area is the remaining part of the display surface.

3. The electronic apparatus of claim 2, wherein the first display area is fully covered by the second display area and the middle display area in the first state.

4. The electronic apparatus of claim 2, wherein the middle display area has a width equal to a width of the part of the part of the first display area uncovered by the second display area in the second state.

5. The electronic apparatus of claim 2, wherein the first display area, the second display area, and the middle display area are all rectangular, and the first display area has an area equal to a sum of an area of the second display area and an area of the middle display area.

6. The electronic apparatus of claim 2, wherein the electronic apparatus further comprises a main board, the main board comprises a controller configured to control display of the first display area, the middle display area, and the second display area according to switch between the first state and the second state of the foldable display screen.

7. The electronic apparatus of claim 6, wherein the controller is configured to turn off the first display area, the middle display area, and the second display area in the first state, and to turn off the middle display area, the second display area, and the remaining part of the first display area covered by the second display area in the second state, and to turn on the part of the first display area in the second state.

8. The electronic apparatus of claim 6, wherein the controller is further configured to turn on the first display area, the middle display area, and the second display area when the foldable display screen is in an unfolded state.

9. The electronic apparatus of claim 6, wherein the electronic apparatus further comprises a first position sensor disposed at the first frame and a second position sensor disposed at the second frame, the first position sensor and the second position sensor are electrically coupled to the controller, and the controller is configured to determine whether the foldable display screen is in the first state, the second state, the folded state according to a relative positional relationship between the first position sensor and the second position sensor.

10. The electronic apparatus of claim 9, wherein the controller is configured to determine that the foldable display screen is in the first state when a distance between the first position sensor and the second position sensor is less than a preset distance, the controller is further configured to determine that the foldable display screen is in the second state when a distance between the first position sensor and the second position sensor is equal to the preset distance, and the controller is further configured to determine that the foldable display screen is in an unfolded state when a distance between the first position sensor and the second position sensor is greater than the preset distance.

11. The electronic apparatus of claim 6, wherein the electronic apparatus further comprises a first pressure sensor disposed at the first frame and a second pressure sensor disposed at the middle frame, the first pressure sensor and the second pressure sensor are electrically coupled to the controller, the controller is configured to determine that the foldable display screen is in the first state when both the first pressure sensor and the second sensor sense pressure, the controller is further configured to determine that the foldable display screen is in the second state when the second sensor rather the first sensor senses pressure, and the controller is further configured to determine that the foldable display screen is in an unfolded state when neither the first pressure sensor nor the second sensor senses pressure.

12. The electronic apparatus of claim 1, wherein the first frame and the middle frame defines a receiving space between the first frame and the middle frame to receive a curved portion of the foldable display screen in the second state, and the second frame and the middle frame define a second receiving space between the first frame and the middle frame to receive a curved portion of the foldable display screen in the second state.

13. The electronic apparatus of claim 1, wherein the electronic apparatus further comprises connecting members, each of the connecting members comprises a pair of first tabs disposed at the middle frame, a pair of second tabs disposed at the second frame or at the first frame, a connecting bar, and a pair of rotating shafts, the connecting bar has an end rotatably connected to the pairs of first tabs through one of the rotating shafts, and another end rotatable connected to the pair of second tabs through the other one of the rotating shafts.

14. An electronic apparatus, comprising
a casing comprising:
a middle frame having a first side and a second side opposite the first side;
a first frame being rotatable relative to the first side of the middle frame; and
a second frame being rotatable relative to the second side of the middle frame; and
a foldable display screen disposed at the middle frame, the first frame, and the second frame of the casing, wherein:
the foldable display screen is operable to be folded along a first folding line corresponding to the first side of the middle frame to be in a first state, and the foldable display screen is operable to be folded along a second folding line corresponding to the second side of the middle frame to be in a second state, the second folding line being parallel to and spaced from the first folding line, the first folding line being a symmetrical center line of the foldable display screen, the foldable display screen being invisible in the first state, part of the foldable display screen being visible and remaining part of the foldable display screen being invisible in the second state, and the foldable display screen being visible in an unfolded state.

15. The electronic apparatus of claim 14, wherein the foldable display screen comprises a first display area corresponding to the first frame, a second display area corresponding to the second frame, and a middle display area corresponding to the middle frame and located between the first display area and the second display area, the second display area covers the middle display area and the remaining part of the display screen in the second state, the part of the foldable display screen is exposed in the second state, and the first display area is fully covered by the second display area and the middle display area in the first state.

16. A foldable display screen, comprising:
a back surface configured to be attached to a casing of an electronic apparatus; and
a display surface opposite the back surface and configured to display visual information,
wherein the foldable display screen is configured to be folded to switch between a first state and a second state, the display surface being invisible in the first state, and part of the display surface being visible and remaining part of the display surface being invisible in the second state.

17. The foldable display screen of claim 16, wherein the display surface further comprises a first display area, a second display area, and a middle display area having opposite sides and disposed between the first display area and the second display area, the first display area is rotatable relative to one side of the middle display area, and the second display area is rotatable relative to the other side of the middle display area.

18. The foldable display screen of claim 17, wherein part of the first display area is exposed in the second state, the second display area covers the middle display area and remaining part of the first display area in the second state, the part of the first display area is the part of the display surface and the remaining part of the first display area is the remaining part of the display surface, and the first display area is fully covered by the second display area and the middle display area in the first state.

19. The foldable display screen of claim 17, wherein the first display area, the second display area, and the middle display area are all rectangular, and the first display area has an area equal to a sum of an area of the second display area and an area of the middle display area.

20. The foldable display screen of claim 19, wherein the middle display area has a width equal to a width of the part of the first display area uncovered by the second display area in the second state.
